(19) United States
(12) Patent Application Publication
(10) Pub. No.: US 2017/0032365 A1
(43) Pub. Date: Feb. 2, 2017

(54) CRYPTO-CURRENCY-BASED ACCRUED VALUE INTEROPERABILITY

(71) Applicant: Mozido, Inc., Austin, TX (US)

(72) Inventors: Michael A. Liberty, Orlando, FL (US); Mike Love, Austin, TX (US); Tiago Soromenho-Ramos, Bethesda, MD (US)

(21) Appl. No.: 15/222,896

(22) Filed: Jul. 28, 2016

Related U.S. Application Data
(60) Provisional application No. 62/199,771, filed on Jul. 31, 2015.

(51) Int. Cl. G06Q 20/36; G06Q 20/40; G06Q 20/20; G06Q 20/10

(52) U.S. Cl. CPC G06Q 20/3678; G06Q 20/10; G06Q 20/4016; G06Q 20/202

(57) ABSTRACT

A crypto-currency based value interoperability computing system for transferring closed-loop value within an accrued value system using crypto-currency is provided. The cyrpto currency based system may include an integration tier operable for managing mobile wallet sessions while maintaining integrity of the session. Notification services may also form part of the system as does a service connector layer. The system may further employ business process services and a payment handler service. Security and authorization services may also provided. The system may further employ use of a mobile device configured to run a cyrpto-currency based value interoperability system application that may involve transfers from and to stored value funding accounts with associated permissions and validation. The system may further include tokenizing the stored value funding account through a toke service provider who may employ a token management system.

### CROSS-REFERENCE TO RELATED APPLICATIONS

This application claims priority to and the benefit of U.S. Provisional Application Ser. No. 62/199,771, titled “Crypto-Currency-Based Accrued Value Interoperability,” filed on Jul. 31, 2015, which is incorporated by reference herein in its entirety.

### BACKGROUND

The move to a purely digital currency is seen by many as inevitable. Certain nations, such as Belgium or the U.A.E. already report that over 98% of their transactions occur through digital means instead of using cash or coins. The U.A.E. wants to be the first country to transition to a cash-free ecosystem and has taken great strides in preparation to that end. Once they take that step, other countries, especially those with public finance challenges stemming from under-reported economic activity (e.g., Greece) may see the benefits of eliminating the cost of printing and minting money, and the benefits of establishing a universally fair economy platform.

The idea of digitizing currencies and applying cryptography to secure the balances and the transactions is not new. Banks have been using digital currency representations for decades. However, the idea of making the transaction record tamper-proof by basing the encryption of one transaction (or block of transactions) on the previous one, and distributing that chain of record across all participating servers is a recent innovation. This chain of records is referred to as a “block chain.” This is one of the main strengths and points of uniqueness for crypto-currency, as initially defined and implemented by Bitcoin.

The underlying concept behind Bitcoin's crypto-currency platform is fairly simple: a ledger is exchanged by all participating nodes of all the transactions that happen anywhere in the Bitcoin ecosystem. These transactions are recorded in “blocks” and the history of all the transactions is the block chain. The uniqueness occurs in the manner by which the transaction blocks are validated and propagated to the rest of the participating nodes. In Bitcoin's platform, this process is based on the nodes solving increasingly complex mathematical challenges that are the basis for encrypting the next block. Within this scheme, individuals may become “miners” that run computer systems to repeatedly calculate hashes with the intention to create a successful block and earn coins from transaction fees and new coins created with the block itself. The first miner to have solved the challenge gains the ability to determine which transactions belong in that next block. Once done, the process starts all over again for the next set of transactions.

This process in Bitcoin currently takes on average about 10 minutes per block. In other crypto-currency variations such as Ripple, the mathematical challenges are used to determine coherence of the proposed block across the nodes, and when enough of them agree, it is determined that consensus is reached, and the block of transactions is now officially part of the block chain. In Bitcoin, the computing-intensive proof-solving and encryption processes also serve to “mine” (or, create) further coins, thus rewarding the participating computing power with more currency—in essence, printing money to pay them for their computing cycles. In Bitcoin, this is a diminishing return endeavor, with a final and limited amount of possible coins that can be eventually created. It is assumed that once that final amount is reached, the inherent need to keep the monetary ecosystem running will be enough to keep the participating computing power up and running.

With the popularity of Bitcoin, variations such as Ripple, Litecoin, Mastercoin and Dash began to appear that addressed certain restrictions that Bitcoin has. These include the completely decentralized aspects of both mining and consensus processes, the speculative aspect of the underlying value of a bitcoin, as well as the time it takes to confirm a transaction (currently about 10 minutes, which make it impractical for day to day commerce).

Bitcoin's block chain, decentralized public ledger, consensus protocols, and specific cryptographic implementations are not a single monolithic concept. They are in fact distinct technologies, each offering unique benefits and limitations.

### BRIEF DESCRIPTION OF THE DRAWINGS

FIG. 1a illustrates a computer architecture in which embodiments described herein may operate including processing transactions.

FIG. 1b highlights the primary components comprised within the MoTeaf enabled crypto-currency environment which facilitates a financial transaction between different MoTeaf platform instances united by a MoziCoin crypto-currency layer.

FIG. 2 highlights an eco system view of the MoTeaf enabled crypto-currency architecture augmented to include external components to facilitate tokenization, credential management and compliance.

FIG. 3 illustrates a closed loop value send process using the MoTeaf enabled crypto-currency architecture.

FIG. 4 illustrates an open loop value send process using the MoTeaf enabled crypto-currency architecture.

FIG. 5 illustrates a loyalty exchange process using the MoTeaf enabled crypto-currency architecture.

FIG. 6 illustrates an exchange of loyalty for money process using the MoTeaf enabled crypto-currency architecture.

FIG. 7 illustrates the use of loyalty as a payment currency using the MoTeaf enabled crypto-currency architecture.

### DETAILED DESCRIPTION

Embodiments described herein are directed to providing a Crypto-currency-based Accrued Value Interoperability processing platform. The embodiments described herein keep the desirable capabilities of current crypto-currencies, and provide systems that fix those parts that are less than optimal for MoTeaf ecosystem participants. To that end, the architectures defined herein integrate the purely distributed and decentralized nature of the public ledger block chain with more centralized controls that can allow for periodic settlements in order to rectify exchange imbalances by basing the consensus nodes on Mozido's MoTeaf platform instances.

Embodiments described herein provide one or more of the following improvements: Centralized ledgers to provide controls over monetary policies, Fast Consensus: When all the nodes are trusted systems, consensus can be exponentially sped up, for block consensus times in the single digit seconds, Routing: advanced algorithms that optimize cross-currency paths to find the most advantageous exchange rates between accrued values (be they Dollars, Dirhams, Points, Miles, etc.), Analytics: for both monitoring the crypto-currency ecosystem for suspicious activity and for monetizing consumer trends, a Central Bank including administrative tools that provide control over the amount of coins in the system as well as control over the consensus process, and Reporting and Compliance Tools to ensure that activity in the system complies with regulations and reporting requirements.

This approach also allows dynamic exchanges between accrued and stored values, such as loyalty balances, as well as secure connectors to other currencies, standard or cryptographic, while keeping national currencies differentiated, controlled, and secured. It also allows a planned and incremental migration towards a pure-digital economy, allowing for inclusion of current systems and regulations. These can then be evolved and transitioned as on-the-ground readiness is achieved across a wide range of current digital payment methods: credit and debit cards use, stored value accounts (SVA) such as gift cards or pre-paid cards, loyalty and rewards programs, and international remittances and foreign currency exchange.

The result is a platform that allows the incremental transition of existing rails and established ways of doing business to increasingly more secure, digital, and indelibly recorded means of transactions on a national scale. The benefits to nation states that adopt this evolutionary path are decreased tax evasion (and thus increased revenues) and elimination of money-enabled black market activity, leading to a greater sense of fairness amongst populations affected by pervasive tax evasion and corruption, which suppresses entrepreneurship and wealth creation.

In the crypto-currency ecosystem described herein, a customized implementation of a digital currency is provided through the MoTeaf platform. It is the back-end orchestrator of many different technologies that ultimately enable the secure and seamless augmentation of current state and a controlled migration towards a 100% digital future. For the end user, most interaction with the MoTeaf platform will occur through an application, referred to herein as the “mVault” app or simply “mVault”. The mVault app provides some or all of the following functionality: Secure storage of financial funding sources (i.e.: credit card or bank routing info), Management of stored values across the national and international ecosystem (e.g., the ability to transfer Miles into Dollars, or Dirhams into Points, etc.), and Controls over how the funding sources are accessed through the tokenization of the underlying funding sources, to merchants and person-to-person payments. The ability to easily add restrictions, limits, notifications, biometrics, etc. to authorize and take control over the payment infrastructure may prove beneficial to (often skeptical) consumers.

It should be noted that the public acceptance aspect is another benefit to the MoTeaf platform: regardless of technical soundness and merits, people must be open and willing to accept this evolution. They must be able to see that they gain from such a system. There are many Game Theory and Behavioral Economy studies that show an increase in acceptance and participation in such ecosystems when participants trust that the system eliminates the ability for others to cheat. A simple example is the Public Goods Game where a single person who figures out a way to make more than their peers in the short term is shown to be able depress and eliminate the benefits in the long to a whole community through the ripple effect of everyone knowing that someone is unfairly gaining at their expense and thus withholding their participation.

To this end, it is important that the fairness and equality of the system is communicated to the public, that change is undertaken in incremental steps over the period of years, and that there exist a range of in-control capabilities that allow a person to feel a sense of increased security, easy and frictionless transactions, and the ability to control their digital money (as opposed to handling physical cash).

Embodiments herein aim toward providing an end-to-end transaction processing environment to enable the goal of achieving a purely digital currency, from the technological platform and agnostic frameworks, to the products that support and protect the ecosystem, to the international nature of the platform and the ability to integrate into the global market, to the evolutionary user experience paths that enable a people to adopt and support the platform.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system 101. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit over a memory bus in which case the address location is asserted on the memory bus itself System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

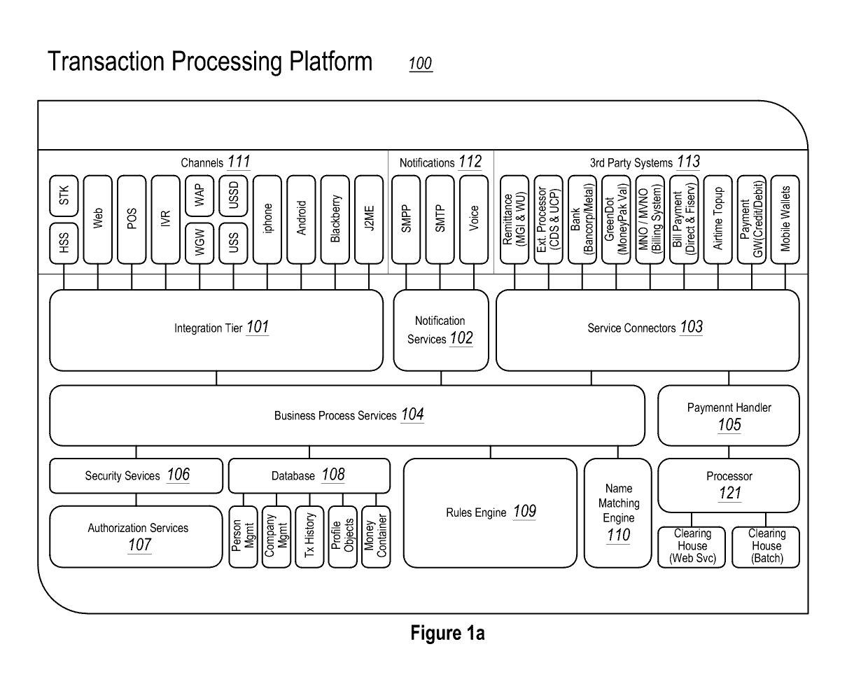

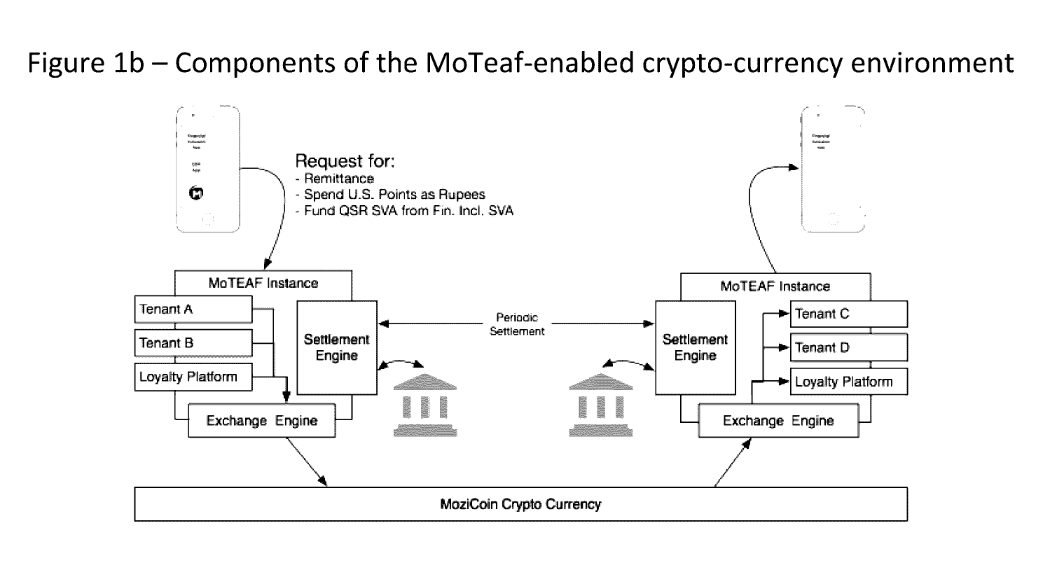

FIG. 1 illustrates an exemplary embodiment of the MoTeaf system architecture for a transaction processing platform supporting the embodiments described herein. This transaction processing platform may be referred to as a transaction processor, a mobile wallet platform, or a “Moteaf platform” herein. Integration tier 101 is configured to manage and maintain the integrity of financial transactions including mobile wallet sessions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to third party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors. Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be used to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, making tokenized payments, and various other tasks as described herein below.

FIG. 1b highlights the primary components comprised within the MoTeaf-enabled crypto-currency environment. The MoTeaf-enabled environment facilitates financial transactions between different MoTeaf platform instances united by a “MoziCoin” crypto-currency layer.

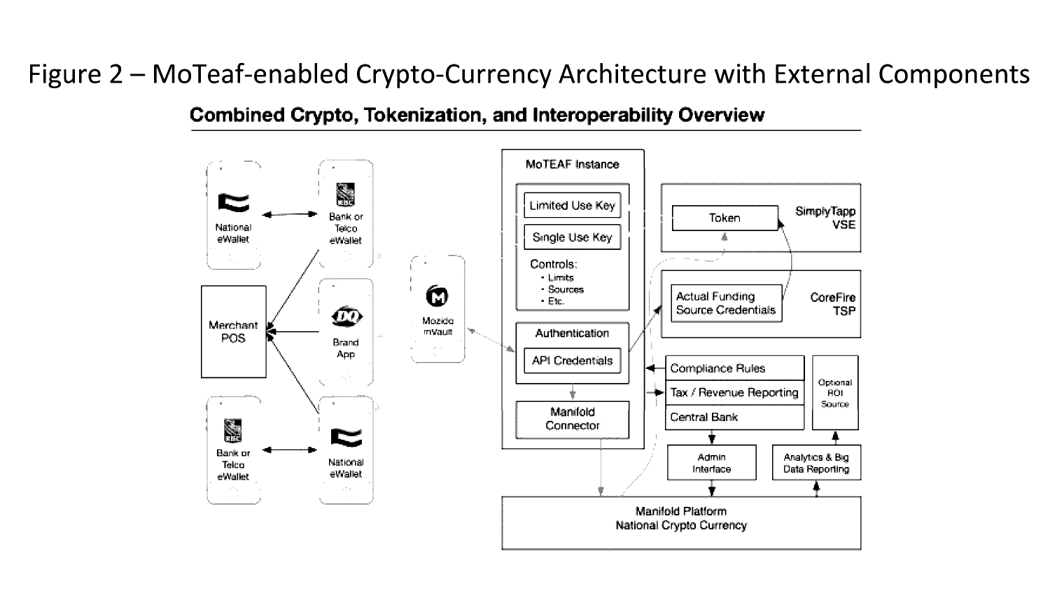

FIG. 2 highlights an ecosystem view of the MoTeaf-enabled crypto-currency architecture augmented to include external components to facilitate tokenization, credential management and compliance. These external components may be provided directly by the MoTeaf-enabled crypto-currency environment, or (at least in some cases) may be provided by third-party providers.

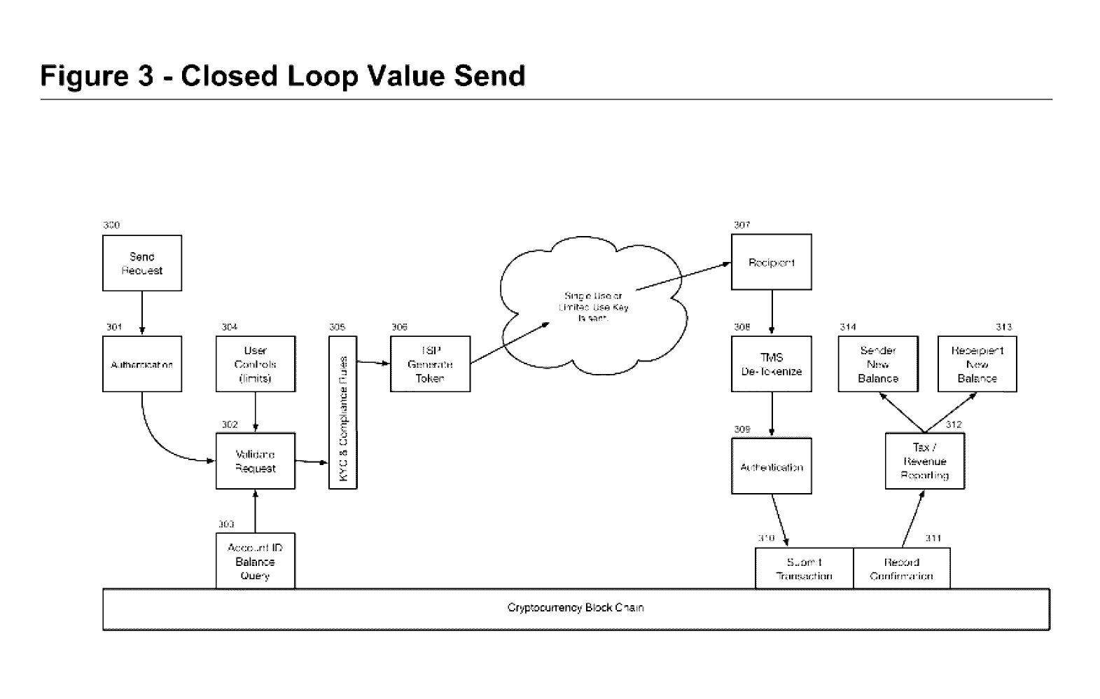

FIG. 3 illustrates a closed loop value send process using the MoTeaf enabled crypto-currency architecture with the following steps: Step 300—A user acting through a client interface initiates a request to send a portion of the accrued balance in their account to a recipient who also has an account in the same accrued value system. This accrued value can be, but is not limited to, currencies, points, miles, visits, etc.

Step 301—The request generated by the interface in (300) is received by an authentication system that validates the user's permissions to make the request. Steps 302 to 304—Once the request in (300) is authenticated in (301), the request is validated against established rules, which include but are not limited to checking if the account balance in the user's underlying crypto-currency account is enough (303), if the user has exceeded certain transfer limits imposed by business rules, or user self-imposed limits implemented by a transaction control system illustrated by (304).

Step 305—The request is further validated against compliance requirements, such as, but not limited to, Know Your Customer (KYC) regulation in the sending and receiving jurisdictions, as well as other compliance checks as dictated by Anti-Money Laundering (AML) and similar regulations to mitigate against fraud and other illegal or suspicious activities, which may require the transaction to be reported, but not impeded.

Step 306—Now that the request has passed all validations and controls, the funding source account is tokenized and encrypted through a Token Service Provider (TSP) service, which allows the transaction to be given some level of controls, such as being limited to a single instance through the issuance of a Single Use Key (SUK) or Limited Use Key (LUK) to restrict the funding source to a single merchant or a defined number of transactions.

Step 307—The recipient receives the payment token through any number of means, whether directly through electromagnetic, visual, auditory, or other means of transferring information between two electronic devices, or indirectly by transmitting the token to the recipient's financial institution or Point of Sale (POS) system that has the ability to notify recipient when the transaction has been completed.

Step 308—The token is passed to a Token Management System (TMS) which will decrypt the token and check the validity of the funding source account. Step 309—Once the funding source account is identified, the recipient's system makes a request to transfer the crypto-currency funds from the sender's account to the recipient's account, and this request is authenticated to make sure the recipient has the permissions to make the request.

Steps 310 to 313—The transfer request is sent to the crypto-currency system to be recorded in the next available block (310). Once the addition of that transaction in a block has been officially added to the crypto-currency's block chain (311), the transaction is reported to agencies based on local sender and receiver's jurisdictions' legal requirements (312) and the recipient is notified of the transaction's success (313).

Step 314—As a result, when the sender checks their transaction history and balance, they will see the transaction recorded and a new balance that reflects the transaction's amount. Additional systems can be put in place that alert the sender when the transaction has successfully completed.

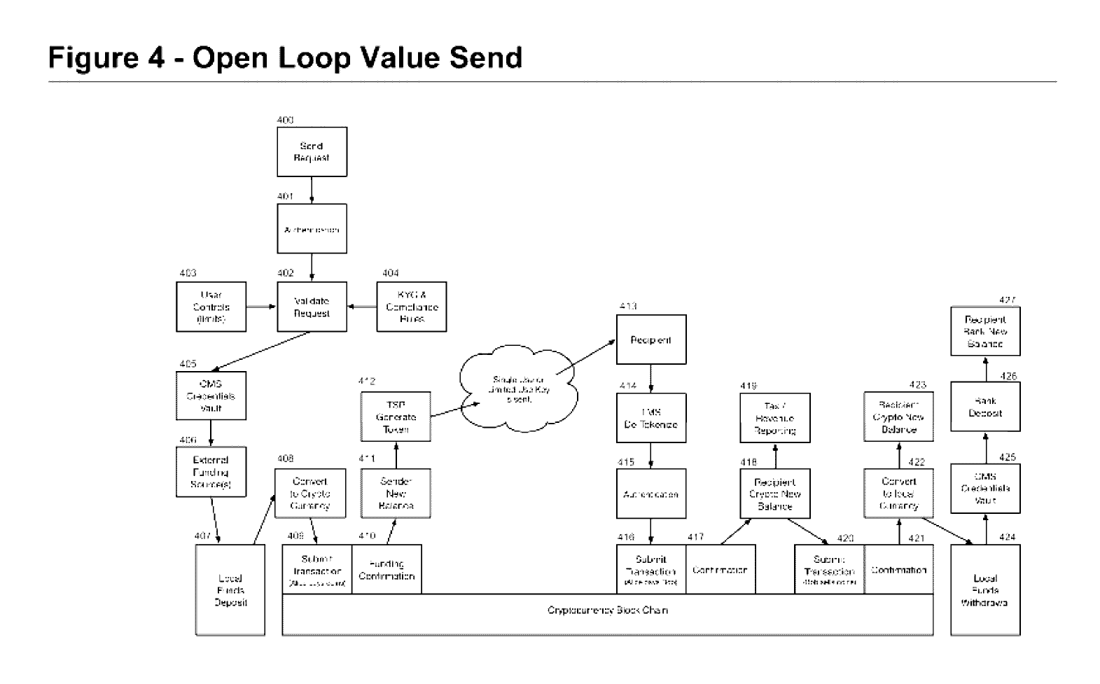

FIG. 4 illustrates an open loop value send process using the MoTeaf enabled crypto-currency architecture with the following steps. Step 400—A user acting through a client interface initiates a request to send a portion of the accrued balance in their account to a recipient who also has an account in the same accrued value system. This accrued value can be, but is not limited to, currencies, points, miles, visits, etc.

Step 401—The request generated by the interface in (400) is received by an authentication system that validates the user's permissions to make the request. Steps 402 to 404—Once the request in (400) is authenticated in (401), the request is validated against established rules, which include but are not limited to checking if the account balance in their underlying crypto-currency account is enough, if the user has exceeded certain transfer limits imposed by business rules, or user self-imposed limits implemented by a transaction control system illustrated by (403). The request is further validated against compliance requirements, such as, but not limited to, Know Your Customer (KYC) regulation in the sending and receiving jurisdictions, as well as other compliance checks as dictated by Anti-Money Laundering (AML) and similar regulations to mitigate against fraud and other illegal or suspicious activities, which may require the transaction to be reported, but not impeded (404).

Steps 405 to 407—If it is determined that the sender's existing balance is too low to fulfill the request, a request to a credentials vault (405) is generated in order to have the proper credentials, such as but not limited to, bank account information, credit or debit card information, etc., in order to generate a funding request (406) to pay for the amount of crypto-currency required to fulfill the request. The funds are received in a pooled account (407) for the local crypto-currency access system or agent.

Steps 408 to 411—Once the funds are received, a transaction to credit the sender with the amount of crypto-currency purchased (408) is sent to the crypto-currency system for the transaction to be recorded in the next available block (409). With confirmation that the transaction is officially part of the crypto-currency block chain (410), the sender's request is resumed with an updated balance that now allows it to proceed (411).

Step 412—Now that the request has passed all checks, validations and controls, the funding source account is tokenized and encrypted through a Token Service Provider (TSP) service, which allows the transaction to be given some level of controls, such as being limited to this one instance through the issuance of a Single Use Key (SUK) or Limited Use Key (LUK) to restrict the funding source to a single merchant or a defined number of transactions.

Step 413—The recipient receives the payment token through any number of means, whether directly through electromagnetic, visual, auditory, or other means of transferring information between two electronic devices, or indirectly by transmitting the token to the recipient's financial institution or Point of Sale (POS) system that has the ability to notify recipient when the transaction has been completed.

Step 414—The token is passed to a Token Management System (TMS) which will decrypt the token and check the validity of the funding source account. Step 415—Once the funding source account is identified, the recipient's system makes a request to transfer the crypto-currency funds from the sender's account to the recipient's account, and this request is authenticated to make sure the recipient has the permissions to make the request.

Steps 416 to 419—The request to transfer crypto-currency funds from the sender's account to the recipient's account is sent to the crypto-currency system to be recorded in the next available block (416). Once the addition of that transaction in a block has been officially added to the crypto-currency's block chain (417), the transaction is reported to agencies based on local sender and receiver's jurisdictions' legal requirements (419) and the recipient is notified of the transaction's success (418).

Steps 420 to 424—The recipient wants to receive their funds in their local currency, so the amount of crypto-currency received is immediately turned into a transaction request to be deducted from the recipient's account (420). Once the confirmation of the successful recording of the transaction in a block added to the block chain (421), the amount of crypto-currency withdrawn is converted (422) to an equivalent amount of currency kept in the local currency pooled account (424).

Steps 425 to 426—A request to a credentials vault (425) is generated in order to have the proper credentials, such as but not limited to, bank account information, credit or debit card information, etc. in order to generate a deposit request (426). Step 427—The recipient receives a notification of the receipt of funds, either through a POS, their wallet app, text message, or any number of electronic means.

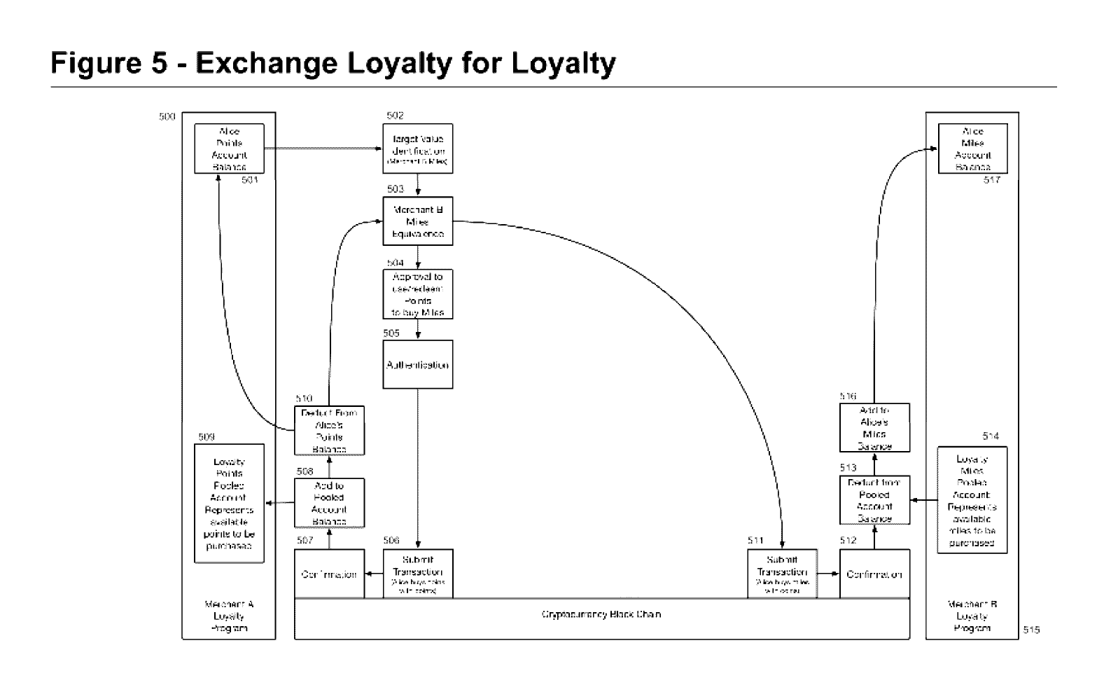

FIG. 5 illustrates a loyalty exchange process using the MoTeaf enabled crypto-currency architecture with the following steps: Steps 500 to 502—A user, acting through a client interface, initiates a request to send a portion of the accrued balance in their account (501) on a loyalty or rewards system (500) to a another account in another accrued value loyalty or rewards system (515). These accrued values can be, but are not limited to, points, miles, visits, status, badges, stars, etc. as long as each has either an intrinsic value, or a value driven by supply and demand.

Step 503—As a result of identifying the target accrual system to exchange the accrued value from the originating system, an exchange value is determined by the parameters and configuration of the underlying crypto-currency platform. In some cases, the exchange rate may be fixed, in which cases the crypto-currency platform will endeavor to find an exchange route that will maintain that value relationship. In other cases, the value will fluctuate based on the supply and demand for each of the originating and destination loyalty system units of accrued value.

Step 504—Once the sender has approved the exchange rate, a request is made to purchase crypto-currency with the originating accrued value. Step 505—The request is received by an authentication system that validates the user's permissions to request the transaction. Step 506—The transfer request is sent to the crypto-currency system to be recorded in the next available block. Steps 507 to 510—Once the addition of that transaction in a block has been officially added to the crypto-currency's block chain (507), the equivalent amount of originating accrued value is deducted (510) from the sender's account (501) and added (508) to a Pooled Account (509) that stores available units of the originating accrued value loyalty or rewards system (500) to be available for others to purchase.

Step 511—A transaction is generated to purchase the equivalent amount of destination accrued value using crypto-currency units and sent to the crypto-currency system to be recorded in the next available block. Steps 512 to 517—Once the addition of that transaction in a block has been officially added to the crypto-currency's block chain (512), the equivalent amount of destination value is deducted (513) from the Pooled Account (514) that stores available units available for purchase of the destination accrued value loyalty or rewards system (515), and that amount is added (516) to the recipient's account (517).

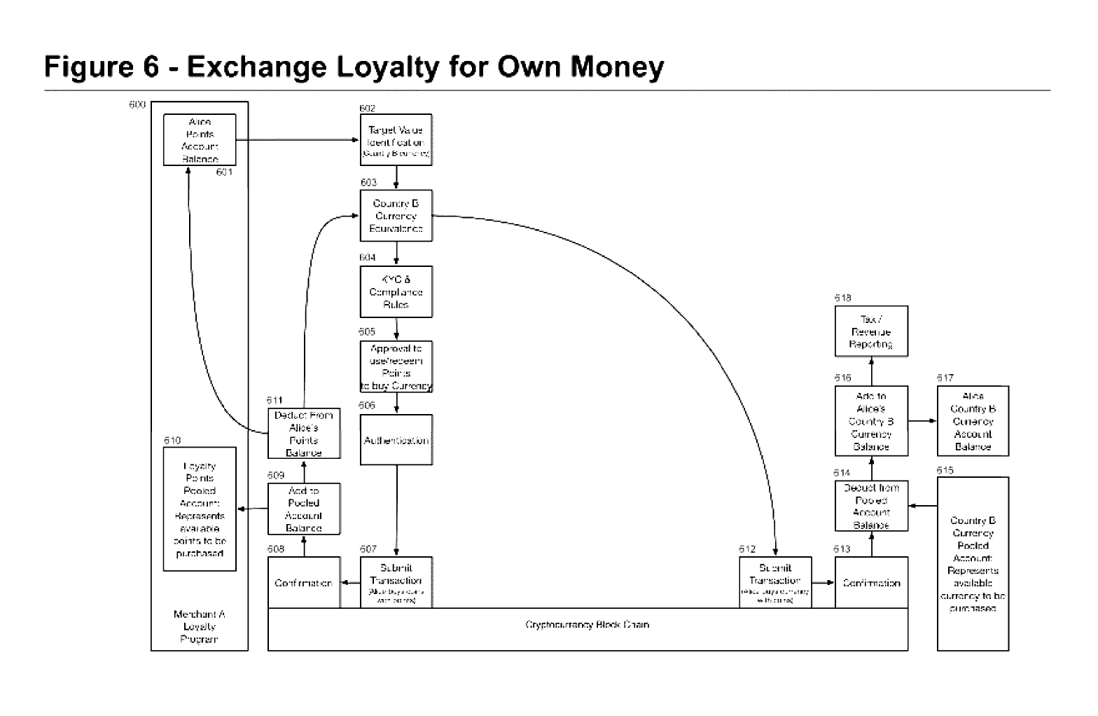

FIG. 6 illustrates an exchange of loyalty for money process using the MoTeaf enabled crypto-currency architecture with the following steps: Steps 600 to 602—A user acting through a client interface initiates a request to send a portion of the accrued balance in their account (501) on a loyalty or rewards system (500) to be exchanged into currency. The originating accrued value can be, but are not limited to, points, miles, visits, status, badges, stars, etc. as long it has either an intrinsic value, or a value driven by supply and demand.

Step 603—As a result of identifying the target currency to exchange the accrued value from the originating system, an exchange value is determined by the parameters and configuration of the underlying crypto-currency platform. In some cases, the exchange rate may be fixed, in which cases the crypto-currency platform will endeavor to find an exchange route that will maintain that value relationship. In other cases, the value will fluctuate based on the supply and demand for each of the originating and destination loyalty system units of accrued value.

Step 604—The request is further validated against compliance requirements, such as, but not limited to, Know Your Customer (KYC) regulation in the sending and receiving jurisdictions, as well as other compliance checks as dictated by Anti-Money Laundering (AML) and similar regulations to mitigate against fraud and other illegal or suspicious activities, which may require the transaction to be reported, but not impeded.

Step 605—Once the sender has approved the exchange rate, a request is made to purchase crypto-currency with the originating accrued value. Step 606—The request is received by an authentication system that validates the user's permissions to request the transaction. Step 607—The transfer request is sent to the crypto-currency system to be recorded in the next available block.

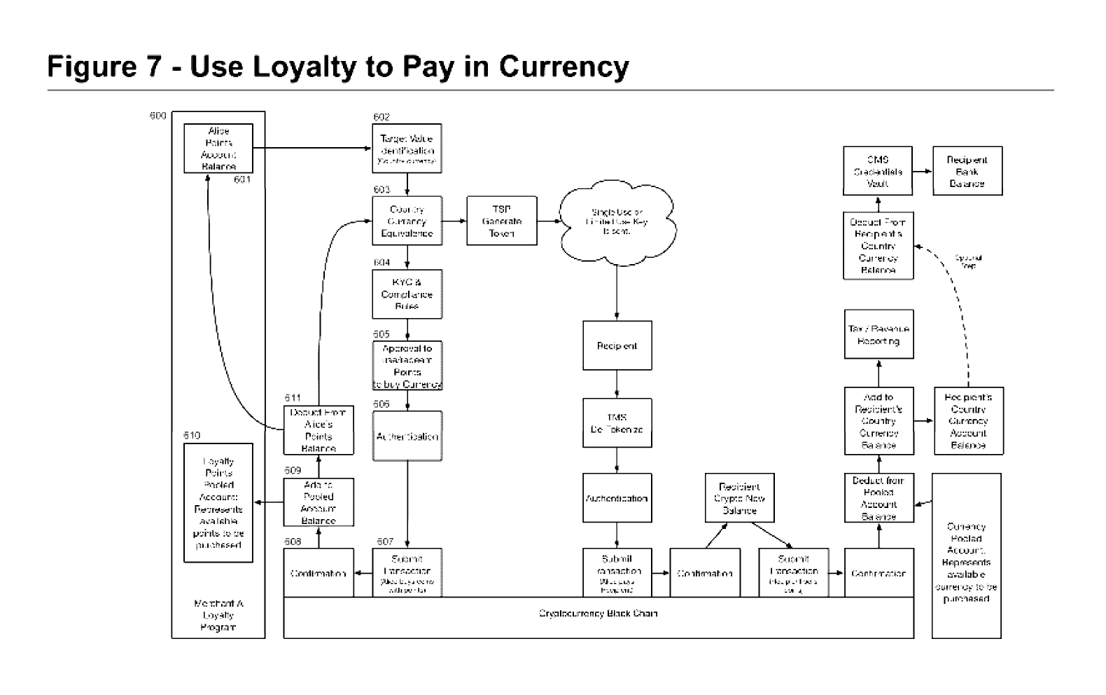

FIG. 7 illustrates the use of loyalty as a payment currency using the MoTeaf enabled crypto-currency architecture with the following steps: Steps 700 to 702—A user acting through a client interface initiates a request to send a portion of the accrued balance in their account (501) on a loyalty or rewards system (500) to be sent to someone else as their local currency. The originating accrued value can be, but are not limited to, points, miles, visits, status, badges, stars, etc. as long it has either an intrinsic value, or a value driven by supply and demand.

Step 703—As a result of identifying the destination and their currency to exchange the accrued value from the originating system to, an exchange value is determined by the parameters and configuration of the underlying crypto-currency platform. In some cases, the exchange rate may be fixed, in which cases the crypto-currency platform will endeavor to find a exchange route that will maintain that value relationship. In other cases, the value will fluctuate based on the supply and demand for each of the originating and destination loyalty system units of accrued value.

Step 704—The request is further validated against compliance requirements, such as, but not limited to, Know Your Customer (KYC) regulation in the sending and receiving jurisdictions, as well as other compliance checks as dictated by Anti-Money Laundering (AML) and similar regulations to mitigate against fraud and other illegal or suspicious activities, which may require the transaction to be reported, but not impeded.

Step 705—Once the sender has approved the transaction's conditions, a request is generated to purchase crypto-currency with the originating loyalty accrued value. Step 706—The request is received by an authentication system that validates the user's permissions to request the transaction. Step 707—The transfer request is sent to the crypto-currency system to be recorded in the next available block.

Steps 708 to 711—Once the addition of that transaction in a block has been officially added to the crypto-currency's block chain (708), the equivalent amount of originating accrued value is deducted (711) from the sender's account (701) and added (709) to a Pooled Account (710) that stores available units of the originating accrued value loyalty or rewards system (700) to be available for others to purchase.

Step 712—Once the sender's crypto-currency account is funded, a request is sent to a Token Service Provider (TSP) system, to tokenize and encrypt the information regarding the sender's source account, which allows the transaction to be given some level of controls, such as being limited to this one instance through the issuance of a Single Use Key (SUK) or Limited Use Key (LUK) to restrict the funding source to a single merchant or a defined number of transactions.

Step 713—The recipient receives the payment token through any number of means, whether directly through electromagnetic, visual, auditory, or other means of transferring information between two electronic devices, or indirectly by transmitting the token to the recipient's financial institution or Point of Sale (POS) system that has the ability to notify recipient when the transaction has been completed.

Step 714—The token is passed to a Token Management System (TMS) which will decrypt the token and check the validity of the funding source account. Step 715—Once the funding source account is identified, the recipient's system makes a request to transfer the crypto-currency funds from the sender's account to the recipient's account, and this request is authenticated to make sure the recipient has the permissions to make the request.

Step 716—The request to transfer crypto-currency funds from the sender's account to the recipient's account is sent to the crypto-currency system to be recorded in the next available block. Steps 717 to 719—Once the addition of that transaction in a block has been officially added to the crypto-currency's block chain (717) a request to record the selling of crypto-currency unites to purchase local currency units is sent (718) to be recorded to the crypto-currency system (719).

Steps 720 to 725—When the transaction has been recorded in a block that is officially added to the crypto-currency block chain (720), the equivalent amount of local currency (703) is deducted from a Pooled Account (722) of the local currency that is available to be purchased, and the same amount is then deposited (723) in the recipient's currency account (724) and the transaction is reported to agencies based on the sender and receiver's local jurisdictions' legal requirements (725).

Steps 726 to 728—If the recipient wants those funds to be deposited instead to an external bank account or other deposit destination, the credentials to request the transfer of funds are retrieved from a Credentials Vault (727) and the amount instructed to be transferred to their destination of choice (728) resulting in a deduction (726) from their local currency account (724).

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer-implemented method for transferring closed-loop value within an accrued value system using crypto-currency, performed at a computing system comprising one or more processors and computing system memory, the method comprising:
the computing system receiving a transfer request to transfer a portion of an accrued balance in a stored value funding account to a receiving account in the same accrued value system;
the computing system validating one or more permissions associated with the transfer request before processing the request;
upon authenticating the transfer request, the computing system validating the transfer request against one or more established rules, including determining whether the underlying crypto-currency account balance in the funding account is sufficient to fulfill the transaction of the transfer request;
upon validating the transfer request, the computing system tokenizing the stored value funding account through a token service provider which provides one or more controls for the transaction;
the computing system sending a payment token to the receiving account using a transmission means;
the computing system receiving an indication from a token management system (TMS) of a second computing system regarding the validity of the stored value funding account;
the computing system receiving a second transfer request to transfer crypto-currency funds from the funding account to the receiving account, wherein the second transfer request is authenticated to make sure the receiving account has the permissions to make the request;
the computing system sending the transfer request to a crypto-currency system to be recorded in the next available transaction block;
the computing system receiving an indication that the transaction block has been officially added to the crypto-currency's block chain;
the computing system reporting the transaction to one or more agencies based on the legal requirements of the location of the funding account and the legal requirements of the location of the receiving account;
the computing system notifying the receiving account of the transaction's success; and
the computing updating the transaction history and balance of the funding account.

2. The method of claim 1, wherein value includes at least one of currencies, points, miles, visits.

3. The method of claim 1, wherein the request is received from a user acting through a client interface.

4. The method of claim 1, further comprising the computing system determining if one or more user-defined limits have been exceeded prior to carrying out the transfer.

5. The method of claim 1, further comprising the computing system further validating the request against compliance requirements including one or more of Know Your Customer (KYC) checks, Anti-Money Laundering (AML) checks, and local regulations that mitigate against fraud.

6. The method of claim 1, wherein the controls provided by the token service provider include being able to limit the transfer to a single instance through the issuance of a Single Use Key (SUK) or Limited Use Key (LUK) to restrict the funding account to a single merchant or a defined number of transactions.

7. The method of claim 1, wherein the transmission means comprises an electromagnetic, visual, auditory, or other means of transferring information between two electronic devices, or indirect transference by transmitting the token to the receiving account's financial institution or Point of Sale (POS) system that has the ability to notify account holders when the transaction has been completed.

8. A crypto-currency based value interoperability computing system for transferring closed-loop value within an accrued value system using crypto-currency the system comprising one or more of:
an integration tier operable to manage mobile wallet sessions and maintain the integrity of financial transactions, the integration tier also including a communication application programming interface (API) and other communication mechanisms to accept messages from channels;
notification services operable to send notifications through different notification channels including one or more of short message peer-to-peer, short-message services and simple mail transfer protocol emails;
a service connector layer comprised of a plurality of service connector modules operable to connect to third party systems, wherein each service connector module is deployed as a separate module intended to integrate an external service to at least a portion of system architecture;
business process services operable to implement business workflows, including at least one of executing financial transactions, auditing financial transactions, invoking third-party services, handling errors, and logging platform objects;
a payment handler service operable to use the APIs of different payment processors including one or more APIs of banks, credit and debit cards processors, bill payment processors; the payment handler service using a common API wrapper to facilitate interactions with many different kinds of payment processors;
a security service operable to perform subscriber authentication;
an authorization service operable to perform client authorization using a database-based access control list table;
a database operable to store financial transaction details, store customer profiles, and manage money containers; and
a rules engine operable to gather financial transaction statistics and use the gathered statistics to enforce business constraints including transaction constraints;
a mobile device configured to run a crypto-currency based value interoperability system application; system configured to perform the following steps:
the computing system receiving a transfer request to transfer a portion of an accrued balance in a stored value funding account to a receiving account in the same accrued value system transfer request received by an API of the integration tier;
the computing system validating one or more permissions associated with the transfer request before processing the request permissions validated by the authorization service;
upon authenticating the transfer request, the computing system validating the transfer request against one or more established rules, including determining whether the underlying crypto-currency account balance in the funding account is sufficient to fulfill the transaction of the transfer request determination made by the rules engine;
upon validating the transfer request, the computing system tokenizing the stored value funding account through a token service provider which provides one or more controls for the transaction;
the computing system sending a payment token to the receiving account using a transmission means token transmitted using an API of the integration tier;
the computing system receiving an indication from a token management system (TMS) of a second computing system regarding the validity of the stored value funding account;
the computing system receiving a second transfer request to transfer crypto-currency funds from the funding account to the receiving account, wherein the second transfer request is authenticated to make sure the receiving account has the permissions to make the request, second transfer request received by an API of the integration tier;
the computing system sending the transfer request to a crypto-currency system to be recorded in the next available transaction block;
the computing system receiving an indication that the transaction block has been officially added to the crypto-currency's block chain;
the computing system reporting the transaction to one or more agencies based on the legal requirements of the location of the funding account and the legal requirements of the location of the receiving account;
the computing system notifying the receiving account of the transaction's success; and
the computing updating the transaction history and balance of the funding account.
